(19) United States
(12) Patent Application Publication
(10) Pub. No.: US 2025/0217902 A1
(43) Pub. Date: Jul. 3, 2025

(54) Building Dispatch Stockpiles with Requisite Chemical Component Compositions

(71) Applicant: TECHNOLOGICAL RESOURCES PTY. LIMITED, Melbourne (AU)

(72) Inventors: Michael Beswick, Melbourne (AU); Peter Mah, Melbourne (AU); Abdul Qadir, Camperdown (AU); Robin Vujanic, Camperdown (AU); Andrew Hill, Camperdown (AU); Steven Scheding, Camperdown (AU); Salah Sukkarieh, Camperdown (AU)

(73) Assignee: TECHNOLOGICAL RESOURCES PTY. LIMITED, Melbourne (AU)

(21) Appl. No.: 18/851,116

(22) PCT Filed: Mar. 27, 2023
(86) PCT No.: PCT/AU2023/050222

§ 371 Date: Sep. 26, 2024

(30) Foreign Application Priority Data
Mar. 28, 2022 (AU) 2022900785

(51) Int. Cl. G06Q 50/02; G06F 17/16; G06Q 10/0631

(52) U.S. Cl. CPC G06Q 50/02; G06F 17/16; G06Q 10/06315

(57) ABSTRACT

A network product planner (29) ascertains material levels required at dispatch stockpiles (15), for example by checking upcoming orders for material to be shipped by transport ships (19) to end customers. Tolerance bands for chemical components required at the dispatch stockpiles are then ascertained. The tolerance bands are defined by upper and lower expected value control limits for each chemical component. The network product planner (29) then passes the collected information to the optimization engine (29a), which finds the values of decision variables in the form of weights, that minimize variance of the chemical components in the dispatch stockpiles, whilst being constrained to comply with the specified tolerance bands of the chemical components. The network product planner (29) then passes the weight values to the rail dispatch controller (23) in messages (14). The rail dispatch controller (23) refers to the weight values when generating schedules for the trains (13) so that as they travel over rail network (11), trains (13) pick up material from mine stockpiles (9) and deposit material to dispatch stockpiles (15) in accordance with the weights to thereby create the dispatch stockpiles with chemical components complying with the tolerance bands and with variance of chemical components minimized.

### RELATED APPLICATIONS

The present application claims priority from Australian provisional patent application No. 2022900785 filed 28 Mar. 2022, the content of which is hereby incorporated by reference in its entirety.

### TECHNICAL FIELD

The disclosure herein concerns a system, method, and apparatus to engineer stockpile composition at dispatch centers, such as ports, to meet required chemical component composition specifications.

### BACKGROUND ART

Customers of mining products usually specify the composition of minerals they require in the product they buy. Mining companies must produce and deliver these products within a specified tolerance band or may have to pay penalties and incur loss of reputation. Most mining operations extract material from several parts of a mine site or from different mine sites and blend the ore to form a product that falls within this range. Blending of ore to form a desirable product has several advantages. In some cases, it reduces the need for further processing/concentration of ore as lower quality ore may be blended with higher quality ore to form the desired product. This not only is cost-effective, but also takes less time. The other major advantage is the reduced risk of the product being out of specifications, based on the “law of large numbers”. In reality, the precise content of ore being mined is not known due to limited assaying, i.e. sampling and testing of ore. These tests provide expected values (means) and variances of chemical components of the ore.

Whilst it is important to produce the final product so that it complies with the specified chemical component composition tolerance band, it is also desirable that the chemical component composition does not vary greatly between dispatch stockpiles. However, providing variance minimization in addition to meeting chemistry component constraints in a pit to port planning context where multiple mine stockpiles feed ore to multiple port stockpiles is a highly challenging technical problem.

It would be advantageous if it were possible to selectively transport material from mine stockpiles to assist in building dispatch stockpiles of ore at dispatch centres, such as ports, to meet chemical component composition tolerance band requirements whilst also improving the consistency of the chemical component composition of the dispatch stockpiles.

Any references to methods, apparatus or documents of the prior art are not to be taken as constituting any evidence or admission that they formed, or form part of the common general knowledge.

### SUMMARY

According to a first aspect there is provided a method of building one or more dispatch stockpiles having one or more chemical components within specified tolerance bands, the method comprising:
determining chemical component compositions of a number of mine stockpiles;
determining values of decision variables, the decision variables indicating mine stockpiles and amounts of material to transport therefrom to build the dispatch stockpiles to meet the specified tolerance bands with minimized variances of the chemical components;
operating an optimization engine configured to determine the values of the decision variables and
effecting transportation of material from the mine stockpiles to the dispatch stockpiles in accordance with the determined values of the decision variables to thereby build the one or more dispatch stockpiles with minimized variance of the one or more chemical components.

In an embodiment the method comprises determining, in each mine stockpile of the number of mine stockpiles, levels of material and expected grades and variances of the one or more chemical components therein.

In an embodiment the method comprises ascertaining the specified tolerance band for each chemical component in the dispatch stockpiles as a range extending from a lower expected value of the chemical component to an upper expected value of the chemical component.

In an embodiment the decision variables indicate proportions of dispatch stockpiles to be acquired from various of the mine stockpiles, to minimize the variances of the one or more of the chemical components of the dispatch stockpiles whilst constrained by the specified tolerance bands.

In an embodiment the method comprises inputting to the optimization engine:
the levels of material and the expected grades and variances of the one or more chemical components thereof in each mine stockpile; and
the tolerance band for each chemical component for the dispatch stockpiles;
In an embodiment the method comprises receiving the values of the decision variables from the optimization engine.

In an embodiment the method comprises determining if the values of the decision variables are feasible with creation of dispatch stockpiles meeting the specified tolerance bands.

In an embodiment the method comprises upon determining that the values of the decision variables are feasible with creation of the dispatch stockpiles meeting the specified tolerance then effecting the transportation of the material from the mine stockpiles to the dispatch stockpiles

In an embodiment the method includes deriving blending targets from the values of the decision variables comprising a number of vehicles to be sent between mines and dispatch centers to carry out dispatch stockpile build proportions according to the values of the decision variables.

In an embodiment the one or more dispatch stockpiles comprise one dispatch stockpile;
the one or more chemical components comprises one chemical component; and
   the optimization engine is configured to find the decision variables w according to the following quadratic program:

$${min}_{w} \\ {w}^{T} \sum w \\ s . t . \\ {w}^{T} 1 = 1 \\ w \geq 0 \\ {w}_{i} * {T}^{p s} \leq {T}_{i} \\ ∀ i ∈ I . \qquad ( 4 )$$

where Σ is a covariance matrix of the chemical component composition of the mine stockpiles and T^{ps} is the level of material required at the dispatch stockpile constrained by the specified tolerance bands.

In an embodiment the one or more dispatch stockpiles comprise multiple dispatch stockpiles;
the one or more chemical components comprises one chemical component; and
the optimization engine is configured to find the decision variables w according to the following quadratic program:

$${\sum }_{j ∈ J} {w}_{j}^{T} \sum {w}_{j} \\ s . t . \\ {w}_{j}^{T} = 1 \\ ∀ j ∈ J \\ {w}_{i} \geq 0 \\ {\sum }_{j ∈ J} {w}_{ij} * {T}_{j}^{p s} \leq {T}_{i} \\ ∀ i ∈ I \qquad ( 5 )$$

and constrained by the specified tolerance bands.

In an embodiment the one or more dispatch stockpiles comprise multiple dispatch stockpiles;
the one or more chemical components comprises multiple chemical components; and
the optimization engine is configured to find the decision variables w according to the following quadratic program:

$${\sum }_{c ∈ C} {\sum }_{{c}^{′} ∈ C} {\sum }_{j ∈ J} {w}_{j}^{T} {\sum }_{c , {c}^{′}} {w}_{j} \\ s . t . \\ {w}_{j}^{T} 1 = 1 \\ ∀ j ∈ J \\ {w}_{i} \geq 0 \\ {\sum }_{j ∈ J} {w}_{ij} * {T}_{j}^{p s} \leq {T}_{i} \\ ∀ i ∈ I \qquad ( 12 )$$

In an embodiment the optimization engine is configured to find the values of the decision variables taking into account that one or more of the dispatch stockpiles may be partially full wherein the constraint:

$$s . t . \begin{matrix}{w}_{j}^{T} 1 = 1 & ∀ j ∈ J\end{matrix}$$

is modified to:

$$s . t . \begin{matrix}{w}_{j}^{T} 1 = 1 - {w}_{j , init} & ∀ j ∈ J\end{matrix}$$

In an embodiment, where an amount of material required in the dispatch stockpiles (Tⱼ ∈R₊) is greater than an amount of material available in the mine stockpiles (Tᵢ∈R₊), then the method comprises transmitting determined values of the decision variables to a rail dispatch controller according to the following quadratic program

$${\sum }_{c ∈ C} {\sum }_{{c}^{′} ∈ C} {\sum }_{j ∈ J} {w}_{j}^{T} {\sum }_{c , {c}^{′}} {w}_{j} - {\sum }_{j ∈ J} {\sum }_{i ∈ I} {w}_{i , j} * {T}_{j}^{ps} \qquad ( 12 a )$$

$$s . t . \begin{matrix}{w}_{j}^{T} 1 \leq 1 & ∀ j ∈ J\end{matrix}$$

$${w}_{i , j} \geq 0 \qquad ∀ i ∈ I , j ∈ J$$

$${\sum }_{i ∈ I} {w}_{i , j} \geq \frac{{T}_{j}^{min}}{{T}_{j}^{ps}} \qquad ∀ j ∈ J$$

$${\sum }_{j ∈ J} {w}_{ij} * {T}_{j}^{ps} \leq {T}_{i} \qquad ∀ i ∈ I$$

In an embodiment the method comprises operating the rail dispatch controller to effect transportation of material from the mine stockpiles to the dispatch stockpiles in accordance with the determined values of the decision variables to thereby build the one or more dispatch stockpiles with minimized variance of the at least one chemical component composition and with compliance with the tolerance bands.

In another aspect there is provided a mining system including a transport network, a network product planner and a vehicle dispatch controller for dispatching vehicles to transport material over the transport network from mine stockpiles to one or more dispatch stockpiles, the network product planner being configured to:
ascertain material levels required at the dispatch stockpiles including required tolerance bands for one or more chemical components at the dispatch stockpiles;
determine values of decision variables that minimize variance of the chemical components in the dispatch stockpiles whilst being constrained to comply with the required tolerance bands;
the vehicle dispatch controller being configured to:
generate schedules for the vehicles based on the values of the decision variables thereby effecting transportation by the vehicles of material from the mine stockpiles to the dispatch stockpiles in accordance with the determined values of the decision variables to thereby build the one or more dispatch stockpiles with minimized variance of the one or more chemical components.

In an embodiment the network product planner determines the values of the decision variables using an optimization engine that is constrained to comply with the required tolerance bands.

In an embodiment the network product planner is configured to derive targets for the vehicle dispatch controller from the values of the decision variables and transmit them to the vehicle dispatch controller in blend target messages.

In an embodiment the vehicle dispatch controller generates the schedules based on the values of the decision variables by referring to the blend target messages.

In an embodiment the targets that are transmitted from the network product planner to the rail dispatch controller in the blend target messages comprise a number of vehicles to be sent between mines and dispatch centers to carry out dispatch stockpile build proportions according to the values of the decision variables.

In an embodiment the mining system includes one or more in-pit mine planners, wherein the network product planner is arranged to provide input to the one or more in-pit mine planners for the in-pit mine planners to build mine stockpiles for improving the set of dispatch stockpiles that can be constructed from the mine stockpiles.

In an embodiment the vehicle dispatch controller is configured to receive information from the network product planner indicating from which mine stockpile material is to be taken, how much material is be taken and to which dispatch stockpiles it is to be transported.

In an embodiment the mining system includes assay stations configured to perform assays on the mine stockpiles and generate expected values of concentrations of chemical components of the mine stockpiles and expected variance values thereof, wherein the assay stations are configured to transmit said concentrations and variance values to the network product planner as assay messages.

In an embodiment the network product planner is configured to receive and process the assay messages to generate mine stockpile to dispatch stockpile movement messages and transmit them to the vehicle dispatch controller.

In an embodiment:
the one or more dispatch stockpiles comprise one dispatch stockpile;
the one or more chemical components comprises one chemical component; and
the optimization engine is configured to find the decision variables w according to the following quadratic program:

$${min}_{w} {w}^{T} \sum w$$

$$s . t . {w}^{T} 1 = 1$$

$$w \geq 0$$

$${w}_{i} * {T}^{ps} \leq {T}_{i} \qquad ∀ i ∈ I .$$

where Σ is a covariance matrix of the chemical component composition of the mine stockpiles and T^{ps} is a level of material required at a dispatch stockpile, constrained by the specified tolerance bands.

In an embodiment:
the one or more dispatch stockpiles comprise multiple dispatch stockpiles;
the one or more chemical components comprises one chemical component; and
the optimization engine is configured to find the decision variables w according to the following quadratic program:

$${\sum }_{j ∈ J} {w}_{j}^{T} \sum {w}_{j}$$

$$s . t . {w}_{j}^{T} = 1 \qquad ∀ j ∈ J$$

$${w}_{i} \geq 0$$

$${\sum }_{j ∈ J} {w}_{ij} * {T}_{j}^{ps} \leq {T}_{i} \qquad ∀ i ∈ I$$

and constrained by the specified tolerance bands, where T^{ps} is a level of material required at a dispatch stockpile, constrained by the specified tolerance bands.

In an embodiment:
the one or more dispatch stockpiles comprise multiple dispatch stockpiles;
the one or more chemical components comprises multiple chemical components; and
the optimization engine is configured to find the decision variables w according to the following quadratic program:

$${\sum }_{c ∈ C} {\sum }_{{c}^{′} ∈ C} {\sum }_{j ∈ J} {w}_{j}^{T} {\sum }_{c , {c}^{′}} {w}_{j} \qquad ( 12 )$$

$$s . t . \begin{matrix}{w}_{j}^{T} 1 = 1 & ∀ j ∈ J\end{matrix}$$

$${w}_{i} \geq 0$$

$${\sum }_{j ∈ J} {w}_{ij} * {T}_{j}^{ps} \leq {T}_{i} \qquad ∀ i ∈ I$$

where T^{ps} is a level of material required at a dispatch stockpile, constrained by the specified tolerance bands.

In an embodiment the optimization engine is configured to find the values of the decision variables taking into account that one or more of the dispatch stockpiles may be partially full wherein constraint:

$$s . t . \begin{matrix}{w}_{j}^{T} 1 = 1 & ∀ j ∈ J\end{matrix}$$

is modified to:

$$s . t . \begin{matrix}{w}_{j}^{T} 1 = 1 - {w}_{j , init} & ∀ j ∈ J\end{matrix}$$

In an embodiment where an amount of material required in the dispatch stockpiles (Tⱼ ∈R₊) is greater than an amount of material available in the mine stockpiles (Tᵢ ∈R₊), then the method comprises transmitting determined values of the decision variables to a rail dispatch controller according to the following quadratic program

$${\sum }_{c ∈ C} {\sum }_{{c}^{′} ∈ C} {\sum }_{j ∈ J} {w}_{j}^{T} {\sum }_{c , {c}^{′}} {w}_{j} - {\sum }_{j ∈ J} {\sum }_{i ∈ I} {w}_{i , j} * {T}_{j}^{ps}$$

$$s . t . \begin{matrix}{w}_{j}^{T} 1 \leq 1 & ∀ j ∈ J\end{matrix}$$

$${w}_{i , j} \geq 0 \qquad ∀ i ∈ I , j ∈ J$$

$${\sum }_{i ∈ I} {w}_{i , j} \geq \frac{{T}_{j}^{min}}{{T}_{j}^{ps}} \qquad ∀ j ∈ J$$

$${\sum }_{j ∈ J} {w}_{ij} * {T}_{j}^{ps} \leq {T}_{i} \qquad ∀ i ∈ I$$

where T^{ps} is a level of material required at a dispatch stockpile, constrained by the specified tolerance bands.

According to another aspect there is provided an ore stockpile build method by which material from I mine stockpiles is transported under control of a rail dispatch controller to create one or more dispatch stockpiles j∈J of ore having one or more chemical component compositions within specified tolerance bands, the method comprising:
monitoring the I mine stockpiles to determine levels of material Tᵢ ∈R₊ available at each mine stockpile i∈I of the mine stockpiles I;
performing assays at each of the mine stockpiles i E I, the assays producing expected grades (πᵢ∈R^{|C|}) and variances (σᵢ²∈R^{|C|}) in respect of one or more chemical components of a set C of chemical components C={c₀, . . . cₙ}; ascertaining material requirement levels Tⱼ∈R₊ at each of the one or more dispatch stockpiles j∈J;
determining values of one or more decision variables w_{i,j} ∈R₊ to minimize a variance of at least one of the chemical components in the at least one dispatch stockpile under constraint of the specified tolerance bands, wherein the decision variables indicate a proportion of a dispatch stockpile j to be sourced from a mine stockpile i to effect the minimizing of the variance;
transmitting determined values of the decision variables to the rail dispatch controller;
operating the rail dispatch controller to effect transportation of material from the mine stockpiles to the dispatch stockpiles in accordance with the determined values of the decision variables to thereby build the one or more dispatch stockpiles with minimized variance of the at least one chemical component composition.

According to a further aspect there is provided an ore stockpile build method by which material from a plurality of mine stockpiles is selectively transported to create one or more dispatch stockpiles having one or more chemical component compositions within specified tolerance bands, the method comprising:
determining, in each mine stockpile of the plurality of mine stockpiles, levels of material and expected grades and variances of one or more chemical components thereof;
ascertaining, for each of the one or more dispatch stockpiles, required levels of material and required grades and variances of the one or more chemical components thereof;
operating an optimization engine configured to determine values of decision variables, the decision variables indicating proportions of dispatch stockpiles to be acquired from various of the mine stockpiles, to minimize variances of one or more of the chemical components of the dispatch stockpiles under constraint of the specified tolerance bands;
inputting to the optimization engine:
   the levels of material and the expected grades and variances of the one or more chemical components thereof in each mine stockpile,
   the required levels of material and tolerance bands of the one or more chemical component compositions for each dispatch stockpile;
   receiving the values of the decision variables from the optimization engine; and
   if the values of the decision variables are feasible with creation of dispatch stockpiles having chemical component compositions meeting the tolerance bands,
   then effecting transportation of material from the mine stockpiles to the dispatch stockpiles in accordance with the determined values of the decision variables to thereby build the one or more dispatch stockpiles with minimized variance of the at least one chemical component component composition.

According to a further aspect there is provided a network product planner configured to implement the method of building one or more dispatch stockpiles.

According to another aspect there is provided a mining system including a transport network in data communication with a product planner, the mining system being configured to implement the method of building one or more dispatch stockpiles.

### BRIEF DESCRIPTION OF THE DRAWINGS

Preferred features, embodiments and variations may be discerned from the following Detailed Description which provides sufficient information for those skilled in the art to perform the various aspects and embodiments. The Detailed Description is not to be regarded as limiting the scope of the preceding Summary in any way. The Detailed Description will make reference to a number of drawings as follows:

FIG. 1 is a stylized plan view of a number of mines, each producing mine stockpiles of extracted material and dispatch stockpiles at a dispatch center in the form of a port.

FIG. 2 is a diagram showing a data network and network product planner of the mining system.

FIG. 3 comprises four graphs comparing the distribution of port (dispatch) stockpile grades for four respective chemical components over 5000 different test scenarios, whether feasible or infeasible, when built according to a variance minimization model (M1) of an embodiment herein vs a base method (M2) that minimizes the difference between the dispatch stockpile chemical components and their respective targets. Vertical black dashed lines are chemical component control limits.

FIG. 4 comprises four graphs corresponding to those of FIG. 3 but showing the distribution of dispatch stockpile grades in feasible scenarios only. Vertical black dashed lines are chemical component control limits.

FIG. 5 is a pair-wise chemical component plot of dispatch stockpiles created by applying weights from M1. Black dashed lines are chemical component control limits.

FIG. 6 is a pair-wise chemical component plot of dispatch stockpiles created by applying weights from M2. Black dashed lines are chemical component control limits.

FIG. 7 is a flowchart of processes implemented by a network product planner to build dispatch stockpiles according to an embodiment herein.

### DETAILED DESCRIPTION OF PREFERRED EMBODIMENTS

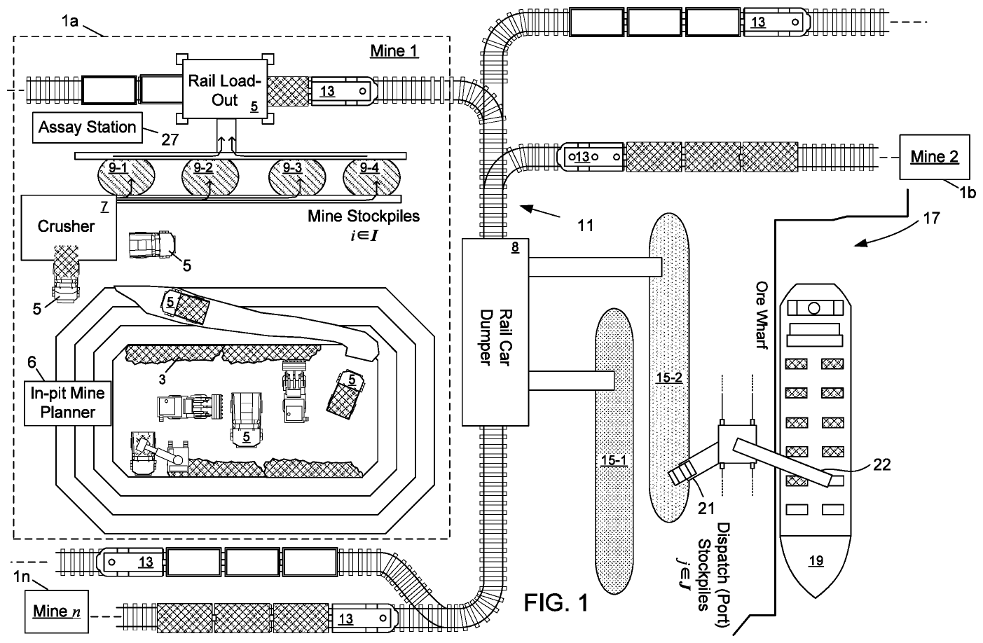

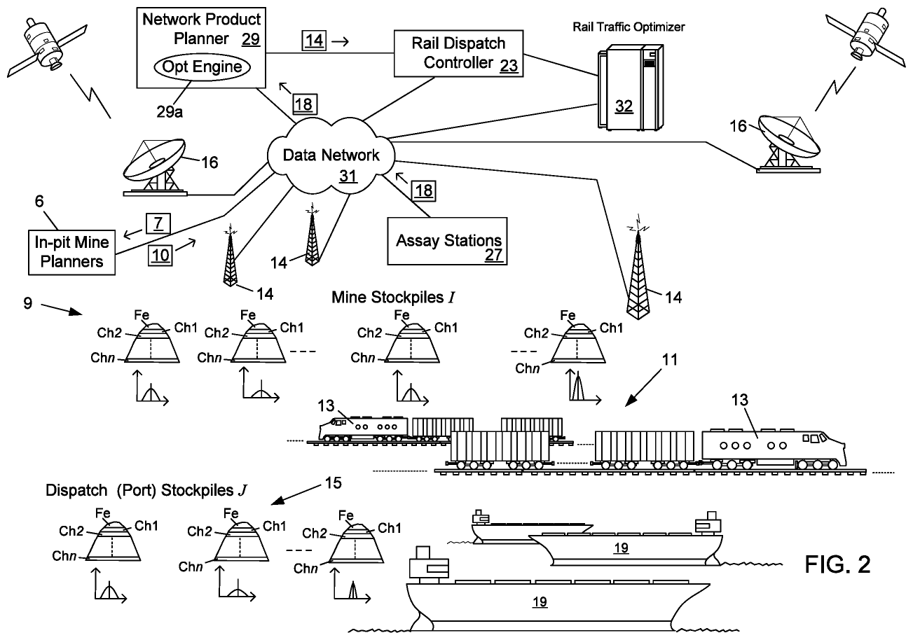

Referring now to FIGS. 1 and 2, a number of mines 1a, . . . , 1n are shown. Mine 1, is shown in some detail whereas the other mines are shown as simplified blocks. In each mine, material, namely blasted ore 3 from a bench of the mine, is loaded on to haul trucks 5 and after preliminary processing, for example by crusher 7, the ore is deposited into i∈I mine stockpiles where I is a set of the mine stockpiles and i is a particular mine stockpile of I. In FIG. 1 four examples of mine stockpiles i∈I are identified as mine stockpiles 9-1, . . . ,9-4 (sometimes referred to generally as “mine stockpiles 9”).

The operation of each mine 1a, . . . , 1n is coordinated by an in-pit mine planner 6 which receives targets for its operation from a network product planner 29 (FIG. 2). The operational targets are received in mine planning messages 7 via a data network 31, which is comprised of terrestrial and satellite communications infrastructure 14, 16. The in-pit mine planner 6 similarly transmits mine reports 10 back to network product planner 29 from time to time.

Mined material, namely ore, is transferred via freight vehicles of a transport network. In the present embodiment the transport network comprises a rail network 11 and the freight vehicles comprises freight trains 13. The rail network 11 is operated to transport material, via rail load-outs 7, from one or more of the mine stockpiles 9 (i∈I) to dispatch stockpiles j∈J, where J is a set of dispatch stockpiles and stockpile j is a particular dispatch stockpile of J. In FIG. 1 two example dispatch stockpiles are identified as dispatch stockpile 15-1 and dispatch stockpile 15-2. In the presently described example the dispatch center comprises a port 17 at which material from dispatch stockpiles 15-1, 15-2 is loaded into transport ships 19 by means of a bucket wheel reclaimer 21 and ship loader 22.

Ore in the dispatch stockpiles 15-1, 15-2 must have requisite chemical component compositions in order to comply with requirements of end customers to which the ore is ultimately shipped by transport ship 19. For example, one or more chemical components, e.g., at least iron (Fe) will be required to be present in an expected tolerance band, which will extend from a lower expected level of the chemical component to an upper expected level of the chemical component. The expected tolerance band will be defined subsequently in equation 14.

With reference to FIG. 2 the network product planner 29 includes an optimization engine 29a to optimize throughput through the rail network 11 and material blend (i.e. conformance to port stockpile chemical component requirements). The network product planner 29 may achieve optimization of the throughput through a form of central coordination (i.e. making decisions about what mines should produce, and how these products should be combined) or by transmitting signals or incentives that influence other controllers in the network (e.g. providing cost functions to localized planners that result in a more balanced global plan in a given time step, or other information that improves the global optimality of localized planners).

In the embodiments that will be described, the network planner 29 does not influence in-pit planning optimization, and rather only acts to optimize the blending of available/planned mine stockpiles 9 into dispatch stockpiles e.g. stockpiles at port 17. The network product planner 29 acts to optimize the blending by providing targets in blend target messages 14 for the rail dispatch controller 23 which responds by allocating trainloads of material from various mine stockpiles 9 to dispatch stockpiles 15 such that the product grade requirements (i.e. expected chemical component grades and variances) are met for all port stockpiles, and the port stockpiles are ready at or before their scheduled completion dates (i.e. ready in time to load on a specified ship). The targets that are provided by the network product planner 29 to the rail dispatch controller 23 are derived from the decision values and comprise the number of trains to be sent between mines and dispatch centers to carry out the build proportions set out in the decision variables.

There is some flexibility in which blocks making up the physical volume of the mine are extracted, and in some embodiments the network product planner 29 may provide input to the in-pit mine planner 6 to influence building of mine stockpiles that will become available over a horizon of days to weeks. This could, for example, be used to cause one or more mines to reduce a specific chemical component impurity (e.g. alumina) in a specific time window (e.g. on day four of a mining plan) in order to improve the possible set of dispatch stockpiles 15 that can be constructed over a full planning horizon across the entire mining system that is illustrated in FIGS. 1 and 2.

Network product planner 29 sends mine stockpile to dispatch stockpile movement messages 14 to the rail dispatch controller 23, which processes the movement messages 14 to assign journeys to trains 13 to perform the movements. The rail dispatch controller 23 also receives input from a rail traffic optimizer 32, which ensures that train resources are allocated efficiently, and the mine stockpile to dispatch stockpile movements that are in the messages 14 from the network product planner are completed in a timely manner.

In order to achieve the objective of controlling the freight train journeys to build the dispatch stockpiles to comply with the prerequisite chemical component composition requirements it is necessary that the rail dispatch controller 23 receives information from the network product planner 29 indicating from which mine stockpiles 9 material should be taken, how much material should be taken and to which dispatch stockpiles 15 it should be transported.

Assay stations 27 are located at each of the mines to perform assays on the mine stockpiles 9. The assay stations 27 process samples from the mine stockpiles 9 to generated expected values of concentrations of chemical components of the different mine stockpiles and also expected variance values of those concentrations. The expected values and variance values are transmitted as assay messages 18 over the data network 31 to the network product planner 29. The network product planner 29 is configured to receive and process the assay messages 18 to generate information in the form of a vector of weights wⱼ^{T} that comprise mine stockpile to dispatch stockpile movement messages 14 that it passes to the rail dispatch controller 23. As will be discussed, the components making up the vector of weights wⱼ^{T} comprise decision variables whose values indicate proportions of dispatch stockpiles j that should be sourced from mine stockpile i in order to build the dispatch stockpile j so that it complies with the prerequisite chemical component composition requirements.

In the following discussion, a method which the network product planner 29 is configured implement, to generate the decision variable vector wⱼ^{T} will explained. Table A below sets out various symbols that are used herein:

TABLE A
List of Symbols

| | |
|---|---|
| c ∈ C | c denotes a chemical component from the set of chemical components |
| | C (e.g., C = {Fe, Ch₁ . . . }). |
| i ∈ I | i denotes a mine stockpile from the set of all mine stockpiles I. |
| j ∈ J | j denotes a dispatch (port) stockpile from the set of all dispatch |
| | stockpiles J. |
| S | The set of mine stockpile i and dispatch stockpile j pairs (i, j), for |
| | which material cannot be transferred from i to j. |
| Tᵢ ∈ R₊ | Tonnes available in mine stockpile i. |
| Tⱼ ∈ R₊ | Tonnes required in dispatch stockpile j. |
| β_{c} | Normalisation factor for standard deviation of chemical component c. |
| πᵢ ∈ R^{\|C\|} | Expected grades (%) of chemical component c in mine stockpile i. |
| σᵢ² ∈ R^{\|C\|} | Variances of chemical component c in mine stockpile i. |
| Σ ∈ Rⁿ^{_{I}}^{×n}^{_{I}} | Covariance matrix |
| w_{i, j} ∈ R₊ | Decision variable indicating the proportion of dispatch stockpile j that |
| | is sourced from mine stockpile i. |

As previously discussed in overview, in a network of mines 1a, . . . , 1n and dispatch centers (ports) 17, ore needs to be moved from mine stockpiles 9 dispatch stockpiles 15 at the port 17. Ultimately, the grades of chemical components of the ore in the dispatch stockpile 15 needs to be within a specified tolerance band and material needs to be sent from mine stockpiles 9 to each destination stockpile 15 in such proportions that these tolerance bands are not violated.

The amount of material that is sent from each mine stockpile 9 to each dispatch stockpile 15 is thus deemed to comprise a decision variable for attaining the objective. The decision variable indicates the proportion of material in a dispatch stockpile j that originates from a mine stockpile i and is denoted by wᵢ ∈R₊. The chemical component composition of mine stockpiles 9 is uncertain and can be represented by the random variable Xᵢ^{mine} ∈R₊. The expected value of the chemical component composition of the dispatch stockpile, E[X^{port}], is given by:

$$E [ {X}^{port} ] = {\sum }_{t = 1}^{n} {w}_{i} E [ {X}_{i}^{mine} ] \qquad ( 1 )$$

Where E[Xᵢ^{mine}] is the expected value of the chemical component composition of mine stockpile i.

The variance of the chemical component composition of the dispatch stockpile 15 can then be expressed by:

$$Var ( {\sum }_{i = 1}^{n} {w}_{i} {X}_{i} ) = {\sum }_{i = 1}^{n} {w}_{i}^{2} Var ( {X}_{i} ) + {\sum }_{i , \hat{i} = 1 , i \neq \hat{i}}^{n} {w}_{i} , {w}_{\hat{i}} Cov ( {X}_{i} , {X}_{\hat{i}} ) \qquad ( 2 )$$

where Cov(Xᵢ,X_{î}) is the covariance of random variables Xᵢ and X_{î}. Equation 2 can be succinctly expressed as:

$$Var ( {\sum }_{i = 1}^{n} {w}_{i} {σ}_{i} ) = {w}^{T} \sum w , \qquad ( 3 )$$

where Σ∈R^{n×n} is the positive semi-definite covariance matrix of Xᵢ,i∈I and n is the number of mine (or “source”) stockpiles. In the following subsections, a model for variance minimisation in a single dispatch stockpile 15 fed by multiple mine stockpiles 19 for a single chemical component will firstly be developed. Subsequently the formulation will be expanded to cater for multiple dispatch stockpiles and chemical components.
i. Single Chemical Component Case

For the case where a single dispatch stockpile 15 is fed from multiple mine stockpiles 9 and the aim is to minimize the variance of chemical component c in the dispatch stockpile, covariance matrix Σ would consist of variance and covariance terms of chemical component c for n_{I} mine stockpiles, where n_{I}=|I|, i.e. n_{I}, is the number of mine stockpiles in I, and thus is the cardinality of I. A quadratic program can be formulated for this as follows:

$$\begin{matrix}{min}_{w} & {w}^{T} \sum w\end{matrix} \qquad ( 4 )$$

$$s . t . {W}^{T} 1 = 1$$

$$w \geq 0$$

$${w}_{i} * {T}^{ps} \leq {T}_{i} \qquad ∀ i ∈ I .$$

The objective in (4) is to minimize the variance of the dispatch stockpile by choosing appropriate w and the sum of the components of w being equal to 1. The second constraint ensures that each component wᵢ of w is non-negative while the last constraint ensures that the amount of material sourced from mine stockpile i is less than or equal to tonnes present in it, where Tᵢ is the tonnes of ore present in stockpile i and T^{ps} is the dispatch stockpile capacity in tonnes.

An additional constraint is that the chemical component composition of the dispatch stockpile must be with a certain tolerance band that the end customer expects. That constraint is set out subsequently in Equation 14.

The formulation of equation 4 can be expanded to include multiple dispatch stockpiles, where the objective is to minimize the sum of the variances of all dispatch stockpiles:

$${\sum }_{j ∈ J} {w}_{j}^{T} \sum {w}_{j} \qquad ( 5 )$$

$$s . t . {w}_{j}^{T} 1 = 1 \qquad ∀ j ∈ J$$

$$w \geq 0$$

$${\sum }_{j ∈ J} {w}_{ij} * {T}_{j}^{ps} \leq {T}_{i} \qquad ∀ i ∈ I$$

Since Σ is positive semi-definite and the feasible set is convex, the model in Equation 5 is convex. The same is true for all optimisation models presented herein.

ii. Multiple Chemical Components Case

It is desirable if the variance of multiple chemical components can be minimised simultaneously. The marginal variance of a chemical component c in dispatch stockpile j is given by:

$${σ}_{j , c}^{2} = {w}_{j}^{T} {\sum }_{c} {w}_{j} \qquad ( 6 )$$

where Σ_{c} is the covariance matrix containing marginal variance and covariance terms with respect to chemical components c of the random variables X_{c} ∈R^{nI}. To minimise the variance of all chemical components in the dispatch stockpile, it is necessary to account for not only the marginal variance of these chemical components but also the covariances between them. The multi-chemical component version of the objective function of Equation 5 would have an expanded covariance matrix Σ∈R⁽ⁿ^{_{I}}^{×n}^{_{C}}^{)×(n}^{_{I}}^{×n}^{_{C}}⁾ and an expanded weights vector wⱼ∈R₊ⁿ^{_{I}}^{×n}^{_{C}}. The covariance matrix can be viewed as a block matrix where the diagonal block elements contain single chemical component variance and covariance terms while the off-diagonal blocks will contain inter chemical component covariance terms. For a set of chemical components C={c₀, . . . cₙ}, the covariance matrix may be expressed as:

$$Σ = [ {σ}_{{c}_{0}}^{2} … {σ}_{{c}_{0} , {c}_{n}} ⋮ ⋱ ⋮ {σ}_{{c}_{n} , {c}_{0}} … {σ}_{{c}_{n}}^{2} ]$$

Where o_{c}² ∈Rⁿ^{_{I}}^{×n}^{_{I}}. With these modified Σ and w, the resultant variance of a product containing n_{C} chemical components can be calculated. With appropriate expansions this overall variance of dispatch stockpile j can be shown to be:

$${σ}_{j}^{2} = {\sum }_{i , \hat{ι} ∈ I} {\sum }_{c , \hat{c} ∈ C} {w}_{i , j} {w}_{\hat{ι} , j} {σ}_{i , \hat{ι} , c , \hat{c}} \qquad ( 7 )$$

where σ_{i,î,c,ĉ} is the covariance of chemical components c and ê between mine stockpiles i and î.

The magnitudes of grades of chemical components in terms of percentage and their variances could be vastly different from one chemical component to another. This warrants normalisation of these variance and covariance terms. A normalisation factor

$${β}_{c} = \frac{{π}_{c , target}}{{\underline{π}}_{c} - {\underline{π}}_{c}} \qquad ( 8 )$$

can be introduced here. The value of β_{c} is inversely proportional to the tolerance of chemical component c and directly proportional to the target value of the chemical component, where π_{c} and π̅_{c} are upper and lower grade control limits and Tc, target is the target grade of chemical component c. After application of β_{c}, (7) becomes:

$${σ}_{j}^{2} = {\sum }_{i , \hat{ι} ∈ I} {\sum }_{c , \hat{c} ∈ C} {w}_{i , j} {w}_{\hat{ι} , j} {β}_{c} {β}_{\hat{c}} {σ}_{i , \hat{ι} , c , \hat{c}} \qquad ( 9 )$$

which can be expressed as:

$${σ}_{j}^{2} = {\sum }_{i , \hat{ι} ∈ I} {w}_{i , j} {w}_{\hat{ι} , j} {σ}_{i , \hat{ι}} \qquad ( 10 )$$

### Where:

$${σ}_{i , \hat{ι}} = {\sum }_{c , \hat{c} ∈ C} {β}_{c} {β}_{\hat{c}} {σ}_{i , \hat{ι} , c , \hat{c}} \qquad ( 11 )$$

By using Equation 11, the size of Σ can be reduced back to its original size Σ∈Rⁿ^{_{I}}^{×n}^{_{I}}.

Consequently, in the situation where the one or more dispatch stockpiles comprise multiple dispatch stockpiles, and the one or more chemical components comprises multiple chemical components, then the optimization engine is configured to find the decision variables w according to the following quadratic program:

$${\sum }_{c ∈ C} {\sum }_{{c}^{′} ∈ C} {\sum }_{j ∈ J} {w}_{j}^{T} {Σ}_{c , c} , {w}_{j} \qquad ( 12 )$$

$$s . t . {w}_{j}^{T} 1 = 1 ∀ j ∈ J$$

$$w \geq 0$$

$${\sum }_{j ∈ J} {w}_{ij} * {T}_{j}^{p s} \leq {T}_{i} ∀ i ∈ I$$

It may occur that an amount of material (i.e. tonnes of material) required in the dispatch stockpiles (Tⱼ ∈R₊) is greater than the tonnes of material available in the mine stockpiles (Tᵢ ∈R₊). In that case a term must be added to the objective function, as shown on the right hand side of the top side of Equation 12a, to maximize tonnes moved and/or add a hard constraint forcing movement of a minimum number of tonnes of ore from mine stockpiles to dispatch stockpiles. Otherwise, zero tonnes will be moved from mine stockpiles to empty dispatch stockpiles, i.e. if variance was minimized only, then the optimizer would keep empty stockpiles empty as that would lead to minimum variance (an empty stockpile has zero variance).

In that case the method comprises transmitting determined values of the decision variables to a rail dispatch controller according to the following quadratic program

$${\sum }_{c ∈ C} {\sum }_{{c}^{′} ∈ C} {\sum }_{j ∈ J} {w}_{j}^{T} {Σ}_{c , {c}^{′}} {w}_{j} - {\sum }_{j ∈ J} {\sum }_{i ∈ I} {w}_{i , j} * {T}_{j}^{p s} \qquad ( 12 a )$$

$$s . t . {w}_{j}^{T} 1 \leq 1 ∀ j ∈ J$$

$${w}_{i , j} \geq 0 ∀ i ∈ I , j ∈ J$$

$${\sum }_{i ∈ I} {w}_{i , j} \geq \frac{{T}_{j}^{min}}{{T}_{j}^{p s}} ∀ j ∈ J$$

$${\sum }_{j ∈ J} {w}_{ij} * {T}_{j}^{p s} \leq {T}_{i} ∀ i ∈ I$$

iii. Operational Constraints

Several operational constraints are relevant. Firstly, one or more dispatch stockpiles may be partially full at the time of running this program. In that case, the first constraint in Equation 5 is modified to:

$${w}_{j}^{T} 1 = 1 - {w}_{j , init} ∀ j ∈ J \qquad ( 13 )$$

Here w_{j,init} is the initial state of the port stockpile. For example, if it is empty, w_{j,init}=0, if it is 50% full, w_{j,init}=0.5.

Control limits must also be adhered to, which requires the chemical component composition of the ore to be within a certain tolerance band. This may be done by introducing the following constraint:

$${\underline{π}}_{j} \leq {w}_{j}^{T} π + {w}_{j , init} {π}_{j , init} \leq {\underline{π}}_{j} ∀ j ∈ J \qquad ( 14 )$$

where πⱼ and πⱼ establish the tolerance band of allowed chemical components for each dispatch stockpile j.

Additionally, there may be cases where some mine stockpiles may not be able to feed some dispatch stockpiles. This could be due to a mismatch of product type between a mine stockpile and dispatch stockpile. For example, ore with certain physical characteristics ore chemical component composition may be shipped as separate products. Mixing of these products would be undesirable. There could also be a mismatch in terms of time of completion of a mine stockpile and dispatch stockpile. A mine stockpile may not be ready by the time a dispatch stockpile needs to be completed or a dispatch stockpile may only be scheduled to start after a mine stockpile is mandated to be fully reclaimed. All these conditions can be determined a priori and so Sis defined as the set of all mine stockpile/dispatch stockpile combinations to which one or more of the conditions above apply. For each combination within set S, there can be no movement of material between the mine stockpile and dispatch stockpile. This can be expressed mathematically as the following constraint:

$${w}_{i , j} \leq 0 ∀ ( i , j ) ∈ S \qquad ( 15 )$$

### IV. Case Study

A case study is conducted on the blending of iron ore where ore from ten mine stockpiles is to be assigned to four dispatch stockpiles. All dispatch stockpiles require the same tonnage and have the same control limits for chemical components, see Table 3. The cumulative amount of ore available in the mine stockpiles is approximately 20% more than the cumulative capacity of the dispatch stockpiles to be filled. In the context of this study, Iron (Fe) and three other chemical components are being tracked and have specified control limits. The tonnes available in each mine stockpile and the means and variances of chemical components of its contents are given in Table 1. The expected values of the chemical components have been normalized and reference is made to three chemical components as Ch1, Ch2 and Ch3. The covariances of chemical components within each mine stockpile are provided in Table 2. Zero covariance between chemical components across mine stockpiles has been assumed (i.e. the covariance between any chemical component in mine stockpile 1 and any component in mine stockpile 2 is zero). Additionally, mine stockpile 1 is expected to be completed after the scheduled completion date of dispatch stockpile 1 while dispatch stockpile 2 is scheduled to start after mine stockpile 2 is supposed to be fully reclaimed. These two mine and dispatch stockpile combinations will form the set S, where S={(1,1),(2,2)}.

TABLE 1
Normalised means, variances and tonnages of all sources

| Mine stockpile | kTonnes | π_{Fe} | π_{Ch1} | π_{Ch2} | π_{Ch3} | σ_{Fe}² | σ_{Ch1}² | σ_{Ch2}² | σ_{Ch3}² |
|---|---|---|---|---|---|---|---|---|---|
| 1 | 127.0 | 1.02 | 0.60 | 0.77 | 1.33 | 1.8e⁻⁵ | 2.3e⁻³ | 4.3e⁻³ | 1.9e⁻³ |
| 2 | 58.6 | 1.01 | 0.59 | 1.00 | 0.44 | 1.1e⁻⁴ | 7.2e⁻³ | 6.8e⁻² | 7.4e⁻⁴ |
| 3 | 93.1 | 1.00 | 0.81 | 0.70 | 0.57 | 2.3e⁻⁴ | 2.3e⁻³ | 7.6e⁻⁴ | 8.8e⁻⁴ |
| 4 | 222.2 | 1.01 | 1.10 | 1.25 | 0.80 | 1.7e⁻⁴ | 3.2e⁻² | 3.1e⁻² | 1.3e⁻² |
| 5 | 169.7 | 0.99 | 1.11 | 1.05 | 0.73 | 6.9e⁻⁵ | 2.7e⁻² | 1.4e⁻² | 1.6e⁻² |
| 6 | 58.1 | 1.01 | 0.65 | 1.04 | 0.41 | 1.2e⁻⁴ | 1.1e⁻² | 7.9e⁻² | 8.9e⁻⁶ |
| 7 | 186.4 | 1.01 | 0.92 | 1.10 | 1.42 | 4.3e⁻⁵ | 1.1e⁻² | 1.7e⁻² | 3.1e⁻³ |
| 8 | 25.7 | 1.03 | 0.50 | 0.87 | 1.33 | 4.0e⁻⁵ | 5.4e⁻³ | 1.8e⁻² | 1.8e⁻³ |
| 9 | 99.1 | 1.00 | 1.22 | 0.71 | 0.53 | 6.2e⁻⁵ | 2.7e⁻² | 1.6e⁻² | 8.8e⁻⁴ |
| 10 | 47.2 | 1.04 | 0.86 | 0.71 | 0.76 | 1.8e⁻⁵ | 1.7e⁻³ | 2.8e⁻³ | 3.5e⁻³ |

TABLE 2
Covariances of all mine stockpiles

| Mine stockpile | σ_{Fe, Ch1} | σ_{Fe, Ch2} | σ_{Fe, Ch3} | σ_{Ch1, Ch2} | σ_{Ch1, Ch3} | σ_{Ch2 ,Ch3} |
|---|---|---|---|---|---|---|
| 1 | −8.8e⁻⁵ | −1.8e⁻⁴ | −7.0e⁻⁶ | −2.7e⁻⁴ | 9.6e⁻⁴ | −1.2e⁻³ |
| 2 | −6.7e⁻⁴ | −2.5e⁻³ | −1.4e⁻⁵ | 1.5e⁻² | 8.3e⁻⁴ | 2.4e⁻⁴ |
| 3 | −7.0e⁻⁴ | 5.4e⁻⁴ | 3.2e⁻⁵ | −2.4⁻³ | −2.0e⁻³ | 5.9e⁻⁴ |
| 4 | −2.0e⁻³ | −1.7e⁻³ | −8.3e⁻⁴ | 1.8e⁻² | 7.8e⁻³ | 1.1e⁻² |
| 5 | −1.1e⁻³ | −6.6e⁻⁴ | −2.9e⁻⁴ | 6.1e⁻³ | 3.7e⁻³ | 8.9e⁻³ |
| 6 | −7.6e⁻⁴ | −2.7e⁻³ | −3.7e⁻⁵ | 1.3e⁻² | 5.9e⁻⁴ | 7.1e⁻⁴ |
| 7 | −6.3e⁻⁴ | −5.6e⁻⁴ | −1.1e⁻⁵ | 6.1e⁻³ | 1.1e⁻³ | 2.7e⁻³ |
| 8 | −4.0e⁻⁴ | −7.2e⁻⁴ | −2.9e⁻⁵ | 8.6e⁻³ | 8.3e⁻⁴ | 8.0⁻⁴ |
| 9 | −1.1e⁻³ | −8.4e⁻⁴ | −1.1e⁻⁴ | 1.2e⁻² | 1.6e⁻³ | −1.4e⁻³ |
| 10 | −2.5e⁻⁵ | −2.0e⁻⁴ | −1.4e⁻⁴ | 7.0e⁻⁴ | 1.0e⁻³ | 4.9e⁻⁴ |

TABLE 3
Required tonnes and chemical component
bounds for all dispatch stockpiles

| Tonnes required | π_{Fe} | π_{Fe} | π_{Ch1} | π_{Ch1} | π_{Ch2} | π_{Ch2} | π_{Ch3} | π_{Ch3} |
|---|---|---|---|---|---|---|---|---|
| 202000 | 1 | 2 | 0 | 1 | 0 | 1 | 0 | 1 |

The Inventors assessed the merits of the variance minimization algorithm developed in section III and compare it to a base case. The base case model is subject to the same constraints as the variance minimization model, but with an objective function that minimizes the difference between the dispatch stockpile chemical components and their respective targets. This objective is given as:

$${\sum }_{j = 1}^{m} {\sum }_{c} {δ}_{j , c} : {δ}_{j , c} = \{ \frac{{w}_{j}^{T} {π}_{c} - {\underline{π}}_{j , c}}{{Δ}_{j , c}} , \frac{{\underline{π}}_{j , c} - {w}_{j}^{T} {π}_{c}}{{Δ}_{j , c}} , \begin{matrix}if c = Fe \\ if c ∈ \{ Ch 1 , Ch 2 , Ch 3 \}\end{matrix} \qquad ( 16 )$$

Where Δ_{j,c}=π_{j,c}−π_{j,c} and δ_{j,c} is the ratio with respect to Δ_{j,c} of the difference between the chemical components c of dispatch stockpile j and the lower control limit in the case of Fe or upper control limit in the case of all other impurities.

For sake of simplicity, the variance minimization model shall be referred to M1 and the base case model shall be referred to M2 in the following sections.

Both models are run to solve for the weights, w*, to be assigned to each mine stockpile for each dispatch stockpile. The optimization termination criteria are given in Table 4. Both models ran quickly and produced solutions in less than 5 seconds. The run times for M1 and M2 and the values of the objective functions from M1 and M2 are summarized in Table 5. The objective functions of M1 and M2 are O₁ (first term in Equation 5) and O₂ (Equation 16). The weights, w*, solved for in each model are given in tables 8 and 9.

The total variance in M1 is less than a third of that of M2. However, M1 also has more than twice the cumulative weighted deviation of grades from target of M2, indicating that in the nominal case M1 will be giving away higher quality material than in M2. This is not desirable as the higher quality material may not fetch a higher price. Nevertheless, in this instance, this is the extra ‘cost’ that the operation incurs as a consequence of reduced variance.

The weights allocated to each mine stockpile are more evenly distributed in M1 than those in M2. This outcome can be attributed to the quadratic form of the objective in M1 which minimizes variance of the product through evenly distributed set of weights for each dispatch stockpile. Mixing of ore from uncorrelated mine stockpiles leads to decrease in the variance as any changes in the chemical component composition of one stockpile will have a very mild or no effect on the chemical component composition of the other mines stockpiles. Overall, the chemical component composition of the dispatch stockpile being fed by these mine stockpiles can be expected to be close to the expected value.

TABLE 4
Termination criteria

| Criteria | Value |
|---|---|
| MIPGap | 1e−4 |
| Primal feasibility tolerance | 1e−6 |
| Dual feasibility tolerance | 1e−6 |
| Time limit (sec) | 360 |

TABLE 5
Results of running models M1 and M2

| | Termination time | | |
|---|---|---|---|
| Model | (sec) | O₁ | O₂ |
| 1 | 0.02 | 1882 | 262 |
| 2 | 0.01 | 6449 | 119 |

TABLE 6
Expected means of each chemical component in dispatch stockpiles

Dispatch stockpile

| Model | Chem | 1 | 2 | 3 | 4 |
|---|---|---|---|---|---|
| M1 | Fe | 1.01 | 1.01 | 1.01 | 1.01 |
| | Ch1 | 0.91 | 0.88 | 0.86 | 0.86 |
| | Ch2 | 0.94 | 0.91 | 0.93 | 0.93 |
| | Ch3 | 0.82 | 0.96 | 0.92 | 0.92 |
| M2 | Fe | 1.00 | 1.00 | 1.00 | 1.01 |
| | Ch1 | 1.00 | 0.95 | 0.97 | 0.90 |
| | Ch2 | 1.00 | 1.00 | 1.00 | 1.00 |
| | Ch3 | 0.67 | 1.00 | 0.86 | 0.84 |

TABLE 7
Expected variances of each chemical
component in dispatch stockpiles

Dispatch stockpile

| Model | Chem | 1 | 2 | 3 | 4 |
|---|---|---|---|---|---|
| M1 | Fe | 8.0e⁻⁶ | 6.0e⁻⁶ | 7.0e⁻⁶ | 7.0e⁻⁶ |
| | Ch1 | 2.3e⁻³ | 2.0e⁻³ | 1.8e⁻³ | 1.8e⁻³ |
| | Ch2 | 2.7e⁻³ | 2.0e⁻³ | 2.3e⁻³ | 2.3e⁻³ |
| | Ch3 | 6.3e⁻⁴ | 6.2e⁻⁴ | 5.6e⁻⁴ | 5.6e⁻⁴ |
| M2 | Fe | 2.3e⁻⁵ | 2.0e⁻⁵ | 3.1e⁻⁵ | 2.0e⁻⁵ |
| | Ch1 | 5.1e⁻⁵ | 6.4e⁻⁵ | 9.7e⁻⁵ | 5.1e⁻⁵ |
| | Ch2 | 8.8e⁻³ | 5.0e⁻³ | 9.9e⁻³ | 5.1e⁻³ |
| | Ch3 | 1.3e⁻³ | 1.4e⁻³ | 5.3e⁻³ | 1.4e⁻³ |

TABLE 8
Weights (w*) assigned to each mine stockpile
for each dispatch stockpile in Model 1

| | |
|---|---|
| Mine | Dispatch stockpile |

| Stockpile | 1 | 2 | 3 | 4 |
|---|---|---|---|---|
| 1 | 0.00 | 0.21 | 0.19 | 0.19 |
| 2 | 0.10 | 0.00 | 0.09 | 0.09 |
| 3 | 0.13 | 0.11 | 0.09 | 0.09 |
| 4 | 0.06 | 0.06 | 0.06 | 0.06 |
| 5 | 0.15 | 0.14 | 0.14 | 0.14 |
| 6 | 0.07 | 0.07 | 0.06 | 0.06 |
| 7 | 0.23 | 0.22 | 0.21 | 0.21 |
| 8 | 0.05 | 0.03 | 0.02 | 0.02 |
| 9 | 0.12 | 0.11 | 0.11 | 0.11 |
| 10 | 0.09 | 0.06 | 0.04 | 0.04 |

TABLE 9
Weights (w*) assigned to each mine stockpile
for each dispatch stockpile in Model 2

| | |
|---|---|
| Mine | Dispatch stockpile |

| Stockpile | 1 | 2 | 3 | 4 |
|---|---|---|---|---|
| 1 | 0.00 | 0.00 | 0.00 | 0.22 |
| 2 | 0.00 | 0.00 | 0.19 | 0.08 |
| 3 | 0.24 | 0.00 | 0.00 | 0.19 |
| 4 | 0.26 | 0.03 | 0.00 | 0.42 |
| 5 | 0.37 | 0.00 | 0.32 | 0.09 |
| 6 | 0.09 | 0.18 | 0.00 | 0.00 |
| 7 | 0.00 | 0.54 | 0.32 | 0.00 |
| 8 | 0.00 | 0.00 | 0.00 | 0.00 |
| 9 | 0.05 | 0.24 | 0.17 | 0.00 |
| 10 | 0.00 | 0.00 | 0.00 | 0.00 |

i. Test Model Solutions Against Possible Mine Stockpile Ground Truth Values

The quality of solutions obtained by optimizing M1 and M2 are evaluated by testing against 5000 different sets of mine stockpile ground truth scenarios. These scenarios are obtained by sampling from a multivariate Gaussian distribution function to determine the grades in the mine stockpiles. The weights obtained from solving M1 and M2 are then applied to each of the scenarios and grades of the resultant dispatch stockpiles are recorded. Based on these results and the grade control limits specified in Table 3, stockpiles are categorized as either feasible or infeasible. Each scenario will produce 4 dispatch stockpiles, thus producing a total of 20,000 stockpiles over all scenarios. The percentage of feasible stockpiles created by applying w* of each model are given in Table 10.

TABLE 10
Feasible and infeasible scenarios created
from applying the solution to each model.

| Model | % of feasible stockpiles |
|---|---|
| M1 | 91 |
| M2 | 34 |

M1, which has an objective function minimizing total variance produces many more feasible dispatch stockpiles than M2, which minimizes the difference between chemical component grades and their targets. M1 is feasible 91% of the time while M2 is feasible only 34% of the time.

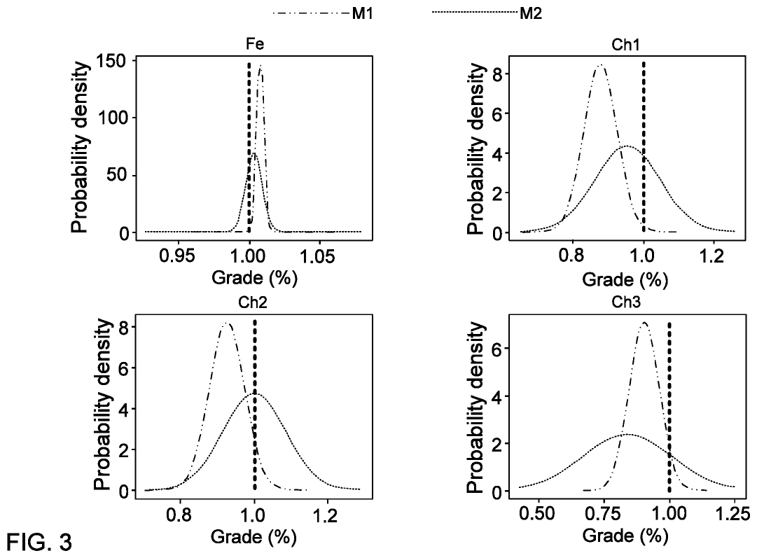

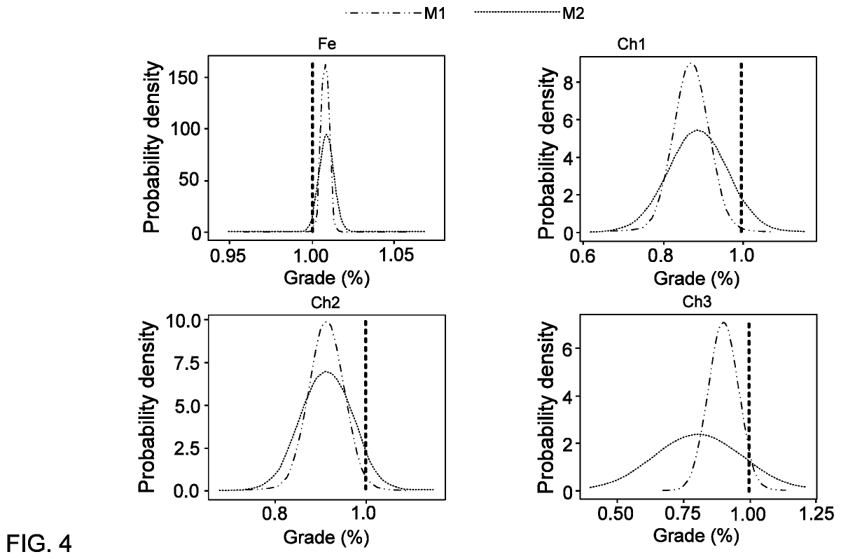

The distribution of grades for Fe, Ch1, Ch2 and Ch3 for all dispatch stockpiles created in the 5000 scenarios for both models are displayed in FIG. 3, while the distribution of these chemical components for only feasible dispatch stockpiles are shown in FIG. 4. When viewing the distributions of chemical components in dispatch stockpiles for all scenarios, it is clear that the distributions of all four chemical components are tighter for scenarios of M1 compared to those of M2. The means of these tighter distributions are all in the feasible region as well (on the right of the control limit for Fe and on the left of the control limit for all other chemical components). The tighter distributions of chemical component grades make it more likely for all grades to be within the feasible region for a dispatch stockpile.

When only considering feasible dispatch stockpiles across all scenarios, it can be seen that the chemical component grades in dispatch stockpiles from scenarios of M1 not only have a tighter distribution but have means that are closer to the control limits. This suggests that these dispatch stockpiles would on average be giving out less high quality material than those in scenarios from M2.

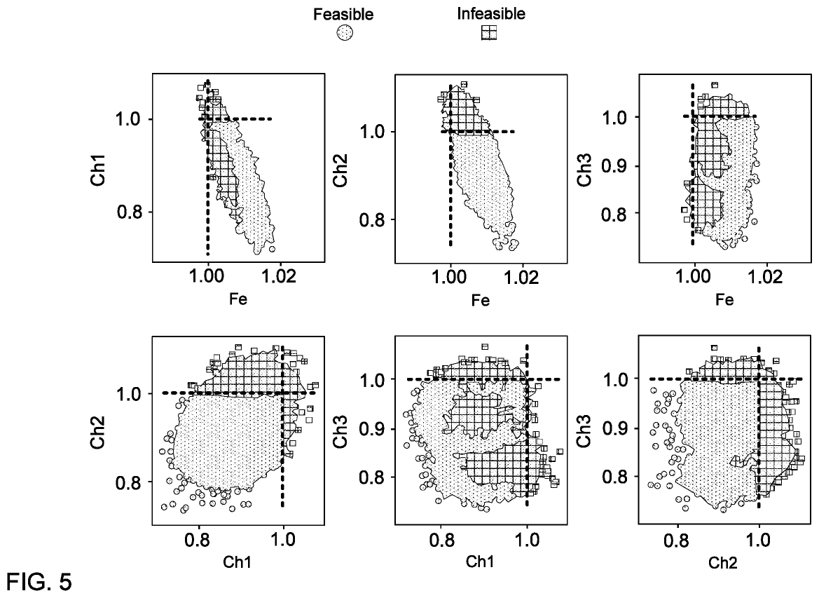

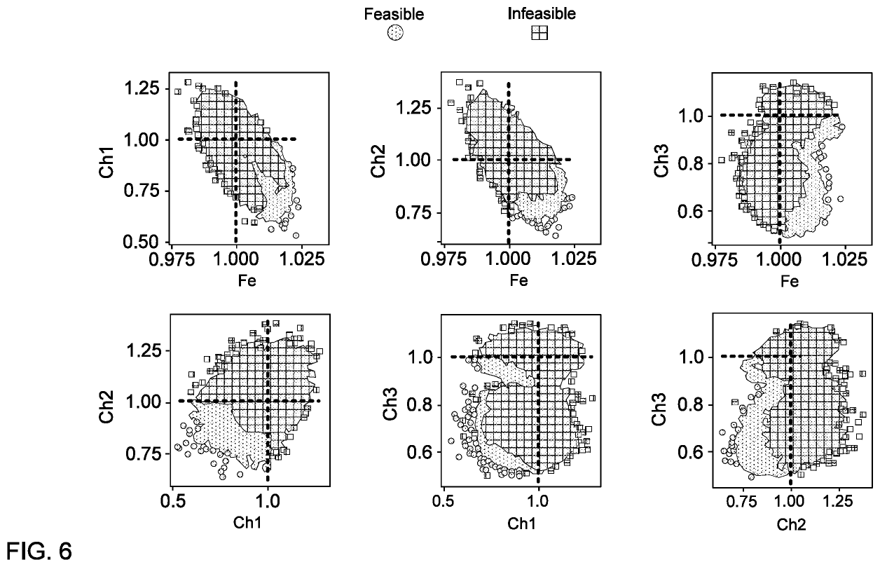

Pair-wise plot of chemical components of all dispatch stockpiles created for all scenarios for models M1 and M2 are shown in FIG. 5 and FIG. 6 respectively. A clear negative covariance between Fe and Ch1 and Fe and Ch2 can be seen. This is reflective of the negative covariance of these chemical components in most mine stockpiles.

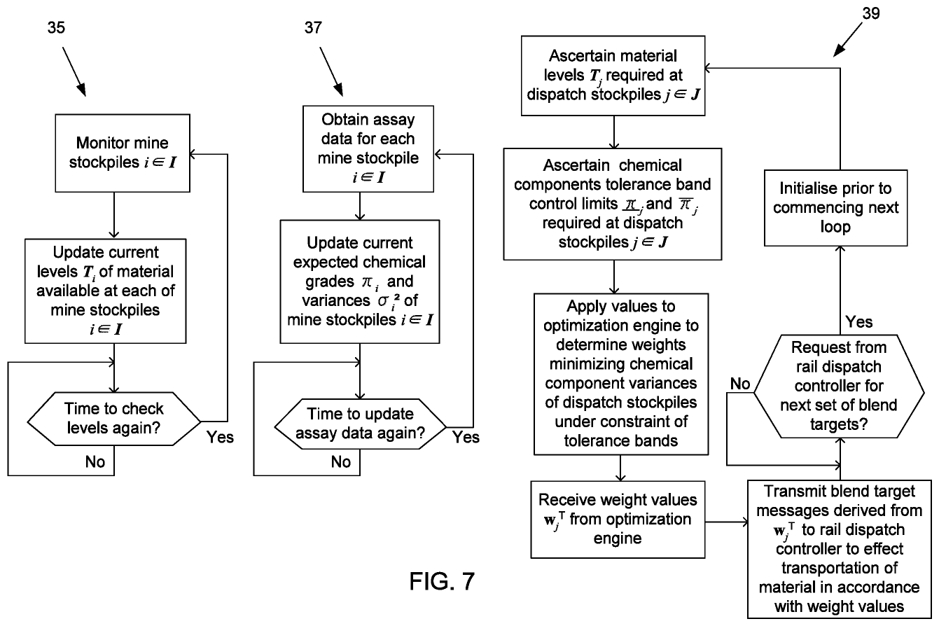

Referring now to FIG. 7, three processes 35, 37, 39 that the network product planner 29 implements are illustrated as flowcharts.

In process 35 the network product planner 29 monitors the mine stockpiles 9 by sending requests via data network 31 to In-pit Planners 6 which in response send back current levels of material available at each of the mine stockpiles 9 in their reports 10.

In process 37 the network product planner obtains assay data for each mine stockpile 9 by sending requests for assay data to the assay stations 27, which respond by transmitting assay reports 18 back.

In process 39 the network product planner 29 ascertains material levels required at dispatch stockpiles 15, for example by checking upcoming orders for material to be shipped by transport ships 19 to end customers. Tolerance bands for chemical components required at the dispatch stockpiles are then ascertained, for example by reference to a specification sheet of the product that is to be offered or if the product is bespoke for a particular customer, then the tolerance bands will be settled on with the customer. The tolerance bands are defined by upper and lower expected value control limits for each chemical component. The network product planner 29 then passes the collected information to the optimization engine 29a. For example, the optimization Engine may be the Gurobi Optimizer provided by Gurobi Optimization, LLC of 9450 SW Gemini Dr. #90729, Beaverton, Oregon, 97008-7105, USA; website: www.gurobi.com. Optimization engine 29a finds the values of decision variables in the form of weights, that minimise variance of the chemical components in the dispatch stockpiles, whilst being constrained to comply with the specified tolerance bands of the chemical components. The network product planner 29 then, preferably after checking that the weights are feasible, passes the weight values to the rail dispatch controller 23 in messages 14. The rail dispatch controller 23 refers to the weight values when generating schedules for the trains 13 so that as they travel over rail network 11, trains 13 pick up material from mine stockpiles 9 and deposit material to dispatch stockpiles 15 in accordance with the weights to thereby create the dispatch stockpiles with chemical components complying with the tolerance bands and with variance of chemical components minimized.

Consequently, a customer receiving a product from a dispatch stockpile can be confident that its chemical components will fall within the specified tolerance bands and also that variation of expected concentrations of the chemical components from dispatch stockpile to dispatch stockpile, for the same target blend, will be minimized.

In compliance with the statute, the various aspects and embodiments have been described in language more or less specific to structural or methodical features. The term “comprises” and its variations, such as “comprising” and “comprised of” is used throughout in an inclusive sense and not to the exclusion of any additional features. It is to be understood that the various aspects and embodiments are not limited to specific features shown or described since the means herein described herein comprises preferred forms

Throughout the specification and claims (if present), unless the context requires otherwise, the term “substantially” or “about” will be understood to not be limited to the value for the range qualified by the terms. The Abstract as lodged with this specification is hereby incorporated herein by reference.

Features, integers, characteristics, moieties or groups described in conjunction with a particular aspect, embodiment or example of herein are to be understood to be applicable to any other aspect, embodiment or example described herein unless incompatible therewith.

Any embodiment is meant to be illustrative only and is not meant to be limiting. Therefore, it should be appreciated that various other changes and modifications can be made to any embodiment described without departing from the scope of the claims.

1. A method of building one or more dispatch stockpiles having one or more chemical components within specified tolerance bands, the method comprising:
determining chemical component compositions of a number of mine stockpiles;
determining values of decision variables, the decision variables indicating mine stockpiles and amounts of material to transport therefrom to build the dispatch stockpiles to meet the specified tolerance bands with minimized variances of the chemical components;
operating an optimization engine configured to determine the values of the decision variables and
effecting transportation of material from the mine stockpiles to the dispatch stockpiles in accordance with the determined values of the decision variables to thereby build the one or more dispatch stockpiles with minimized variance of the one or more chemical components.

2. The method of claim 1 comprising, determining, in each mine stockpile of the number of mine stockpiles, levels of material and expected grades and variances of the one or more chemical components therein.

3. The method of claim 1 comprising, ascertaining the specified tolerance band for each chemical component in the dispatch stockpiles as a range extending from a lower expected value of the chemical component to an upper expected value of the chemical component.

4. The method of claim 1, wherein the decision variables indicate proportions of dispatch stockpiles to be acquired from various of the mine stockpiles, to minimize the variances of the one or more of the chemical components of the dispatch stockpiles whilst constrained by the specified tolerance bands.

5. The method of claim 1, comprising inputting to the optimization engine:
the levels of material and the expected grades and variances of the one or more chemical components thereof in each mine stockpile; and
the tolerance band for each chemical component for the dispatch stockpiles.

6. The method of claim 5, comprising receiving the values of the decision variables from the optimization engine.

7. The method of claim 1, comprising determining if the values of the decision variables are feasible with creation of dispatch stockpiles meeting the specified tolerance bands.

8. The method of claim 7, comprising upon determining that the values of the decision variables are feasible with creation of the dispatch stockpiles meeting the specified tolerance then effecting the transportation of the material from the mine stockpiles to the dispatch stockpiles.

9. The method of claim 1, including deriving blending targets from the values of the decision variables comprising a number of vehicles to be sent between mines and dispatch centers to carry out dispatch stockpile build proportions according to the values of the decision variables.

10. The method of claim 5, wherein
the one or more dispatch stockpiles comprise one dispatch stockpile;
the one or more chemical components comprises one chemical component; and
the optimization engine is configured to find the decision variables w according to the following quadratic program:
$${min}_{w} {w}^{T} Σ w \qquad ( 4 )$$
$$s . t . {W}^{T} 1 = 1$$
$$w \geq 0$$
$${w}_{i} * {T}^{p s} \leq {T}_{i} ∀ i ∈ I .$$
where Σ is a covariance matrix of the chemical component composition of the mine stockpiles and T^{ps} is a level of material required at a dispatch stockpile, constrained by the specified tolerance bands.

11. The method of claim 5, wherein
the one or more dispatch stockpiles comprise multiple dispatch stockpiles;
the one or more chemical components comprises one chemical component; and
the optimization engine is configured to find the decision variables w according to the following quadratic program:
$${\sum }_{j ∈ J} {w}_{j}^{T} Σ {w}_{j} \qquad ( 5 )$$
$$s . t . {w}_{j}^{T} = 1 ∀ j ∈ J$$
$${w}_{i} \geq 0$$
$${\sum }_{j ∈ J} {w}_{ij} * {T}_{j}^{p s} \leq {T}_{i} ∀ i ∈ I$$
and constrained by the specified tolerance bands, where T^{ps} is a level of material required at a dispatch stockpile, constrained by the specified tolerance bands.

12-14. (canceled)

15. A mining system including a transport network, a network product planner and a vehicle dispatch controller for dispatching vehicles to transport material over the transport network from mine stockpiles to one or more dispatch stockpiles, the network product planner being configured to:
ascertain material levels required at the dispatch stockpiles including required tolerance bands for one or more chemical components at the dispatch stockpiles;
determine values of decision variables that minimize variance of the chemical components in the dispatch stockpiles whilst being constrained to comply with the required tolerance bands;
the vehicle dispatch controller being configured to:
generate schedules for the vehicles based on the values of the decision variables thereby effecting transportation by the vehicles of material from the mine stockpiles to the dispatch stockpiles in accordance with the determined values of the decision variables to thereby build the one or more dispatch stockpiles with minimized variance of the one or more chemical components.

16. The mining system of claim 15, wherein the network product planner determines the values of the decision variables using an optimization engine that is constrained to comply with the required tolerance bands.

17. The mining system of claim 15, wherein the network product planner is configured to derive targets for the vehicle dispatch controller from the values of the decision variables and transmit them to the vehicle dispatch controller in blend target messages; or
wherein the network product planner is configured to derive targets for the vehicle dispatch controller from the values of the decision variables and transmit them to the vehicle dispatch controller in blend target messages, and the vehicle dispatch controller generates the schedules based on the values of the decision variables by referring to the blend target messages.

18. (canceled)

19. The mining system of claim 17, wherein the targets that are transmitted from the network product planner to the rail dispatch controller in the blend target messages comprise a number of vehicles to be sent between mines and dispatch centers to carry out dispatch stockpile build proportions according to the values of the decision variables.

20. The mining system of claim 15, including one or more in-pit mine planners, wherein the network product planner is arranged to provide input to the one or more in-pit mine planners for the in-pit mine planners to build mine stockpiles for improving the set of dispatch stockpiles that can be constructed from the mine stockpiles.

21. The mining system of claim 15, wherein the vehicle dispatch controller is configured to receive information from the network product planner indicating from which mine stockpile material is to be taken, how much material is be taken and to which dispatch stockpiles it is to be transported.

22. The mining system of claim 15, including assay stations configured to perform assays on the mine stockpiles and generate expected values of concentrations of chemical components of the mine stockpiles and expected variance values thereof, wherein the assay stations are configured to transmit said concentrations and variance values to the network product planner as assay messages; or
including assay stations configured to perform assays on the mine stockpiles and generate expected values of concentrations of chemical components of the mine stockpiles and expected variance values thereof, wherein the assay stations are configured to transmit said concentrations and variance values to the network product planner as assay messages, wherein the network product planner is configured to receive and process the assay messages to generate mine stockpile to dispatch stockpile movement messages and transmit them to the vehicle dispatch controller.

23. (canceled)

24. The mining system of claim 16, wherein
the one or more dispatch stockpiles comprise one dispatch stockpile;
the one or more chemical components comprises one chemical component; and
the optimization engine is configured to find the decision variables w according to the following quadratic program:
$${min}_{w} {w}^{T} Σ w$$
$$s . t . {W}^{T} 1 = 1$$
$$w \geq 0$$
$${w}_{i} * {T}^{p s} \leq {T}_{i} ∀ i ∈ I .$$
where Σ is a covariance matrix of the chemical component composition of the mine stockpiles and T^{ps} is a level of material required at a dispatch stockpile, constrained by the specified tolerance bands.

25.-28. (canceled)

29. An ore stockpile build method by which material from I mine stockpiles is transported under control of a rail dispatch controller to create one or more dispatch stockpiles j∈J of ore having one or more chemical component compositions within specified tolerance bands, the method comprising:
monitoring the I mine stockpiles to determine levels of material Tᵢ ∈R₊ available at each mine stockpile i∈I of the mine stockpiles I;
performing assays at each of the mine stockpiles i∈I, the assays producing expected grades (πᵢ∈R^{|C|}) and variances (σᵢ² ∈R^{|C|}) in respect of one or more chemical components of a set C of chemical components C={c₀, . . . cₙ};
ascertaining material requirement levels Tⱼ∈R₊ at each of the one or more dispatch stockpiles j∈J;
determining values of one or more decision variables w_{i,j}∈R₊ to minimize a variance of at least one of the chemical components in the at least one dispatch stockpile under constraint of the specified tolerance bands, wherein the decision variables indicate a proportion of a dispatch stockpile j to be sourced from a mine stockpile i to effect the minimizing of the variance;
transmitting determined values of the decision variables to the rail dispatch controller;
operating the rail dispatch controller to effect transportation of material from the mine stockpiles to the dispatch stockpiles in accordance with the determined values of the decision variables to thereby build the one or more dispatch stockpiles with minimized variance of the at least one chemical component composition.

30. (canceled)
